(19) United States
(12) Patent Application Publication
(10) Pub. No.: US 2012/0312135 A1
(43) Pub. Date: Dec. 13, 2012

(54) METHOD FOR SLICING OF PRODUCTS

(75) Inventor: Joachim Schaub, Hatzfeld-Reddighausen (DE)

(73) Assignee: Weber Maschinenbau GmbH Breidenbach, Breidenbach (DE)

(21) Appl. No.: 13/486,352

(22) Filed: Jun. 1, 2012

(30) Foreign Application Priority Data
Jun. 9, 2011 (DE) 102011103864.0

(51) Int. Cl. B26D 7/06; B26D 7/01

(52) U.S. Cl. 83/13; 83/409; 83/72

(57) ABSTRACT

In a method for slicing products, a plurality of products is fed next to one another along a product feed direction to a cutting plane in which a cutting blade moves. The rear ends of the products are brought into engagement with respective product grippers which are attached to a common feed unit and are extendable independently of one another relative to the feed unit in the product feed direction and are retractable against the product feed direction. The feed unit is moved along the product supply direction in a product position search run towards the products for the bringing into engagement of the product grippers with the rear ends of the products, wherein, during the product position search run, the current position of the product gripper is determined as the product end position for each product gripper on a contact with the rear end of the associated product.

The present invention relates to a method for slicing products, in particular food products.

Various kinds of food slicing apparatus are known in the prior art. For example, so-called high-performance slicers are used to slice food products, such as meat, sausage or cheese, at high speeds. In an endeavor to increase the slicing performance, such apparatus can comprise a product feed which is designed to feed a plurality of product loaves or product bars—hereinafter: products—next to one another along a product feed direction to a cutting plane in which at least one cutting blade moves. The cutting blade can, for example, be a circular blade revolving in a planetary motion manner or a rotating scythe-like blade. In this manner, it is possible to use a single cutting apparatus—with a correspondingly large blade—for simultaneously cutting a plurality of products.

The common feed of products can be effected in that each product is assigned its own product gripper which engages at the rear end of the product to push the product forward. In order to compensate for differences in the weight distribution or in the cross-sectional distribution of the products and to be able to vary the thickness of the cut-off product slices for the fed products independently of one another during slicing in order thus to individually achieve a predefined weight of individual product slices or to individually achieve the weight of portions comprising a plurality of slices, the product grippers can be secured at a common feed unit and can be extendable independently of one another relative to the feed unit in the product feed direction and can be retractable against the product feed direction.

When loading the product feed with new products to be sliced, it can generally not be ensured that all products located next to one another have exactly the same length. Since the product grippers are movable independently of one another relative to the feed unit, a difference in length of the products can be compensated by appropriate adjustment of the product grippers relative to one another. For this purpose, however, the difference in length must be known in advance, which is not usually the case. Therefore, a product position search run can be performed to determine the positions of the rear ends of the products. Conventionally, during the product position search run, the feed unit is moved along the product feed direction towards the products with fully retracted product grippers until the gripper associated with the longest product abuts the rear end thereof. Since the longest product can be considerably compressed in this respect, the feed unit is subsequently moved back by a certain distance so that the longest product can relax again. Starting from this position of the feed unit, the individual product grippers are now moved towards the products while the feed unit is stationary. The product grippers in this manner individually search for the respective rear product end and establish an engagement upon contacting it, for example, by closing corresponding gripping claws.

It is problematic in this respect that, due to the required backward movement of the feed unit, the entire movement range of the product grippers cannot be used for compensating the difference in product length. In particular, it should be noted that the product gripper associated with the longest product also requires a respective “search path”. Furthermore, the backward movement of the feed unit takes time, which is detrimental to the effectiveness of the cutting apparatus.

It is therefore an object of the invention to design the product position search run more effectively in a method for slicing food products as described above.

This object is satisfied by a method having the features of claim 1.

According to the invention, the current position of the product gripper is determined as the product end position for every product gripper when contacting the rear end of the associated product during the product position search run. In this manner, it is possible to determine the product end position of all products in a single product position search run of the feed unit and thus to create the precondition for a subsequent correct positioning of the product grippers relative to one another. In particular, a time-consuming relaxation run of the feed unit with subsequent search runs of the individual product grippers can be omitted. When loading the product feed with new products to be sliced, significant time savings can be achieved.

Further developments of the invention are specified in the dependent claims, the description and the accompanying drawings

Preferably, the product grippers are, at least in part, extended up to a maximum end position prior to the product position search run. The product position search run of the feed unit can thus be continued after one of the product grippers contacts the associated product. Due to the retraction movement of the product gripper, an uncontrolled compression of the product is avoided.

According to an embodiment of the invention, during the product position search run, the feed unit is continuously moved in the product feed direction, in particular at a constant speed. In other words, the movement of the feed unit during the product position search run takes place without interruption in order to achieve a rapid bringing into engagement of all product grippers with the respective products.

Preferably, during the product position search run, the product grippers are not moved relative to the feed unit up to a contact of the rear ends of the products. In particular, all product grippers can be stationary at the maximum end position up to a contact of the rear ends of the products in order thus to use the maximum operating range for compensating the differences in product length. Products can then be simultaneously sliced, the length of which differs by at most the maximum movement range of the product grippers.

According to an embodiment of the invention, after the contact at the rear end of the product, a retractive movement is started for each product gripper, the speed of which is at least as high in magnitude as the speed of the feed unit during the further product position search run. In this manner, a compression of the products is reliably avoided.

Prior to the product position search run, respective electric drives of the product grippers can be displaced into a position-regulated state. In this state, for example, the electric current supplied to the drives is essentially constant. An electrical operating variable of a drive of the product gripper can be monitored for detecting a contact of a product gripper with the rear end of the associated product, in particular, the electric current supplied to the drive can be monitored. An abutment of the product gripper at the rear end of the product can thus be detected easily and economically via a change in the electrical operating variable.

A contact of the product gripper with the rear end of the associated product can in particular be detected when the electric current supplied to a drive of the product gripper exceeds an average value determined prior to the product position search run, preferably by a predetermined threshold value. An abutment of the product gripper at the product namely inevitably results in a current increase due to the position regulation. This approach is in particular characterized by its simple performability. If it should be required by the application, however, separate sensor devices, such as contact sensors, can also be provided at the product grippers for detecting a contact of a product gripper with the rear end of the associated product.

After the product position search run, the product grippers can be positioned relative to one another according to the determined product end positions. This means that the individual product grippers are extended so far that their relative differences in position correspond to the differences in length of the products.

The feed unit can be moved, prior to positioning the product grippers, against the product supply direction away from the products to move to a starting point for a final engagement run.

According to a further embodiment of the invention, the positioning of the product grippers is performed starting from the product gripper associated with the longest product, with in particular this product gripper being retracted completely. In this manner, the maximum movement range for compensating the difference in product length can be used.

After positioning the product grippers, all the product grippers can simultaneously be brought into engagement with the rear ends of the products. This means that the feed unit is moved towards the products in the conventional manner, where due to the previous positioning, all the product grippers simultaneously impact the respective rear ends of the products.

After the positioning of the product grippers, all of the product grippers are preferably simultaneously brought into engagement with the rear ends of the products, in that, e.g. respectively controlled gripping claws for all product grippers are simultaneously closed. This is possible without problem since the product grippers are extended at different distances such that the existing differences in product length are compensated.

The front ends of the products can be supported at an abutment at least during the product position search run. It is thereby ensured that a difference in the position of the rear ends of the products reflects the underlying difference in product length. In addition, an unwanted displacement of the products on a contact of the rear product end with the associated product gripper is avoided.

The determining of the positions of the product grippers as product end positions can respectively include the determining of the position of the feed unit relative to the cutting plane or to a reference point in relation with the cutting plane. If the product grippers are at a defined position relative to the feed unit during the product position search run, the positions of the product grippers are also determined by such position determinations of the product feed.

The invention also relates to an apparatus for slicing products, in particular food products, with a product feed in order to feed a plurality of products next to one another along a product feed direction to a cutting plane in which a cutting blade moves, in particular, in a rotating and/or revolving manner, wherein the product feed comprises a common feed unit, fastened to which are respective product grippers for an engagement with the rear ends of the products, wherein the product grippers are extendable independently of one another relative to the feed unit in the product feed direction and are retractable against the product feed direction, wherein a control device is provided which is designed to move the feed unit in a product position search run along the product feed direction towards the products for the bringing into engagement of the product grippers with the rear ends of the products and to determine the current position of the product gripper as the product end position during the product position search run for each product gripper on a contact with the rear end of the associated product. The control device can be a separate device associated with the product grippers or the feed unit. Alternatively, the control device can also be integrated into a higher-level control device of the cutting apparatus, in particular a high-performance slicer.

Preferably the control device cooperates with a detection device which is designed to detect a respective contact of one of the product grippers with the rear end of the associated product. The detection device can in particular be a touch sensor or a proximity sensor or an optical device.

The invention will be described by way of example in the following with reference to the drawings.

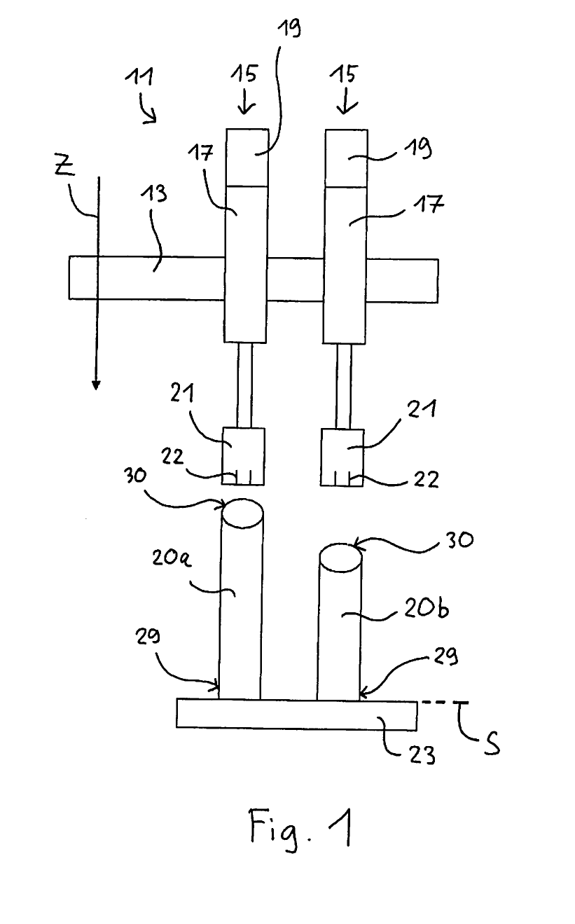

FIG. 1 is a plan view of a product feed of a cutting apparatus according to the invention in a first phase of a product position search run;

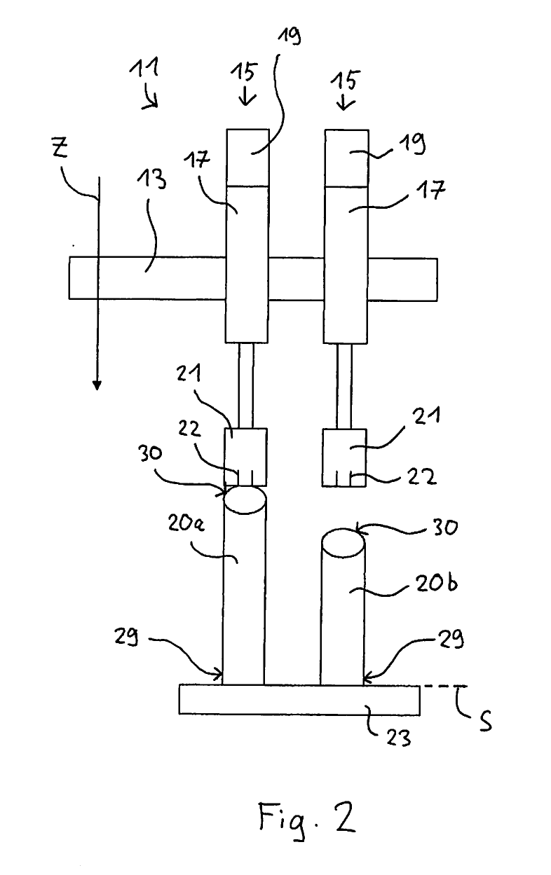

FIG. 2 shows the product feed of FIG. 1 in a second phase of the product position search run;

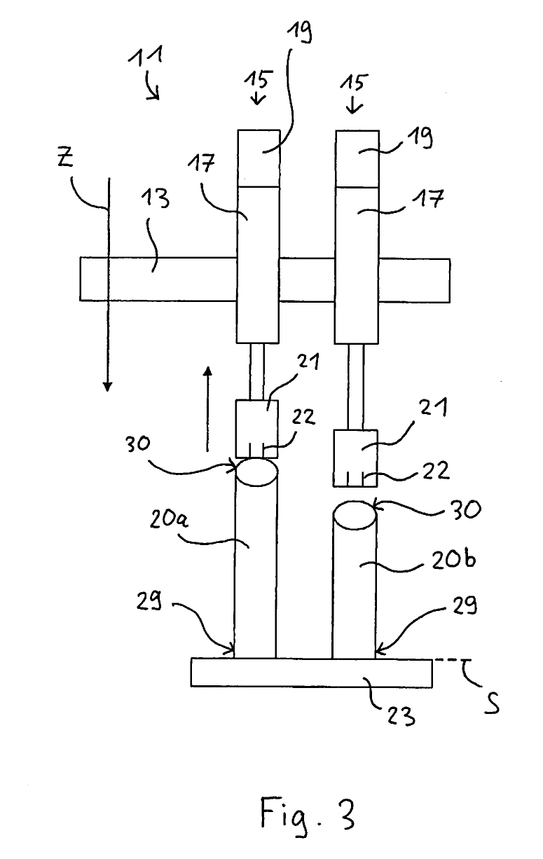

FIG. 3 shows the product feed of FIG. 1 in a third phase of the product position search run;

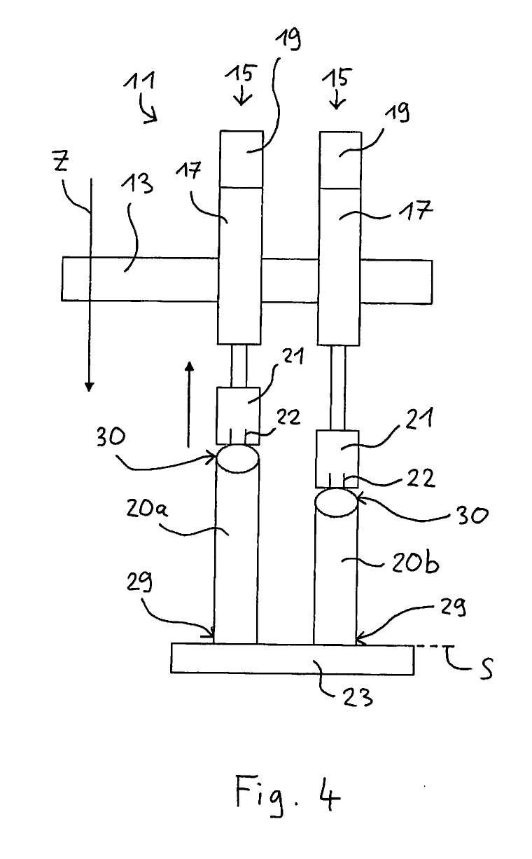

FIG. 4 shows the product feed of FIG. 1 in a fourth phase of the product position search run;

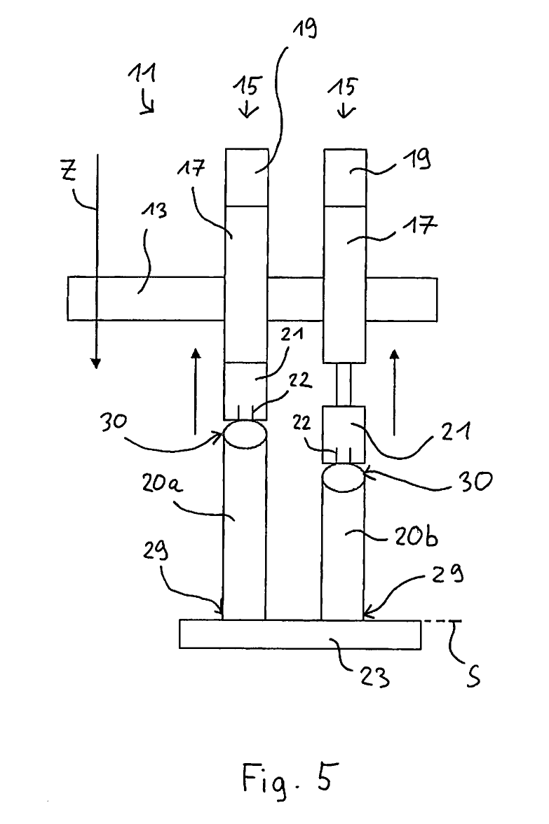

FIG. 5 shows the product feed of FIG. 1 in a fifth phase of the product position search run; and

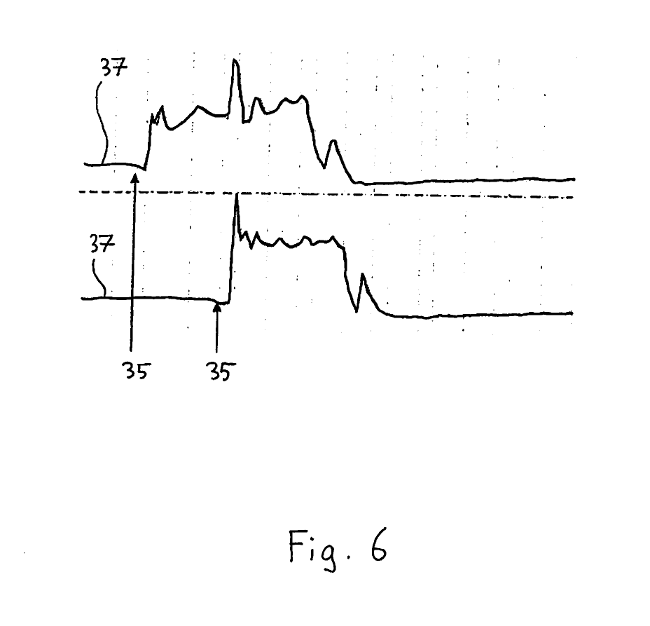

FIG. 6 is a diagram illustrating the current increase of the electrical drives of product grippers of the product feed of FIG. 1 on a contact with the rear ends of the products.

FIG. 1 shows a cutting apparatus according to an embodiment of the invention in simplified form. The cutting apparatus comprises a product feed 11 with a feed unit 13 and two product gripper modules 15 arranged next to one another. The product gripper modules 15 each comprise a product gripper base 17 and a product gripper 21, with the product gripper 21 being extendable relative to the product gripper base 17 in a product feed direction Z and being retractable against the product supply direction Z by means of an electric drive 19 provided at the product gripper base 17. Each of the product grippers 21 is provided with a set of controlled gripping claws 22 which can be brought into engagement with a rear end 30 of a product 20a, 20b lying on a product support, not shown, of the product feed 11. The feed unit 13, designed in the form of a holding arm aligned transverse to the product feed direction Z, can—also be moved by means of a drive, not shown, in the product feed direction Z and against the product supply direction Z, while carrying the product gripper modules 15.

When the gripping claws 22 of the product grippers 21 grip the rear ends 30 of the products 20a, 20b, a simultaneous feed of both products 20a, 20b can be effected by moving the feed unit 13 in the product supply direction Z, in the direction of a cutting plane S in which a cutting blade, not shown, moves. The cutting blade cuts through the two products 20a, 20b disposed next to one another at a constant cutting frequency, wherein the thickness of the product slices cut off from the products 20a, 20b can be varied separately for each product 20a, 20b by retracting and extending movements of the product grippers 21 during the feed.

Depending on the application, three or more product gripper modules 15 can also be attached next to one another at the feed unit 13.

In order to bring the product grippers 21 into engagement with the rear ends 30 of the products 20a, 20b when loading the product feed 11 with the new products 20a, 20b to be sliced, an electronic control device, not shown, of the product feed 11 causes a product position search run which takes place prior to the actual slicing process. For carrying out the product position search run, the products 20a, 20b are placed on the product support of the product feed 11 and the front ends 29 of the products 20a, 20b are supported at an abutment 23. The abutment 23 is displaceable or pivotable so that it can later be removed from the feed path for the products 20a, 20b prior to the start of the slicing process. Furthermore, both product grippers 21 are extended to a maximum end position prior to the product position search run, as shown in FIG. 1. The electric drives 19 of the product grippers 21 are set into a position-controlled state.

The product position search run is now started in that the feed unit 13 is moved by means of its separate drive in a single continuous movement with the fully extended product grippers 21 along the product feed direction Z towards the products 20a, 20b.

As can be recognized from the Figures, the product 20a at the left in the image is longer than the product 20b at the right. Therefore, the product gripper 21 at the left in FIG. 2 first impacts the rear end 30 of the product 20a during the product position search run. As soon as this contact of the product gripper 21 with the rear end 30 of the longer product 20a is detected, the current position of the feed unit 13 is determined relative to a reference point fixed relative to a housing as the current product end position and is buffered in a memory of the control device.

A retraction movement is simultaneously started for the left product gripper 21, the speed of which is exactly as high in its magnitude as the constant speed of the feed unit 13 during the further product position search run. This is illustrated by an arrow in FIG. 3.

As soon as, the right product gripper 21 also contacts the rear end 30 of the shorter product 20b, as shown in FIG. 4, the current position of the feed unit 13 is in turn determined and is stored as the product end position. A retraction movement is simultaneously also started for the right product gripper 21, the speed of which is exactly as high in its magnitude as the constant speed of the feed unit 13 during the further product position search run. The movement of the feed unit 13 towards the products is now continued for the two product grippers 21 of FIG. 5 while maintaining the retraction movement until the left product gripper 21 is entirely retracted.

In principle, the gripping claws 22 can now be closed in order thus to bring both product grippers 21 into engagement with the products 20a, 20b. If it should be desired due to the application, however, the feed unit 13 can, in a further method step, also again be moved back, i.e. away from the products 20a, 20b. In a retracted position of rest of the feed unit 13, the positioning of the product grippers 21 relative to one another can then be performed according to the differences of the stored product end positions, wherein, in a subsequent separate engagement run, the feed unit 13 is again moved towards the products 20a, 20b. Since the positions of product grippers 21 relative to one another now differ by the difference in product length, any further product position search run of the product grippers 21 is no longer necessary. The closing of the gripping claws 22 can rather be effected directly and simultaneously as soon as the overall arrangement of the product grippers 21 has reached the products 20a, 20b. This can, for example, be determined via the drive of the feed unit 13.

In order to detect a respective contact of a product gripper 21 with the rear end 30 of the associated product 20a, 20b, suitable touch sensors can basically be provided at the product gripper 21. In a preferred embodiment, such sensors are saved, however, in that the electric current supplied to the drives 19 is monitored during the product position search run. Since the drives 19 are in a position-controlled state during the product position search run, the magnitude of the electric current is essentially constant during the product position search run. A time line of the current is shown in the upper part of FIG. 6 for the left product gripper 21 and in the lower part of FIG. 6 for the right product gripper 21. As soon as the product grippers 21 abut the products 20a, 20b, the current increases relatively steeply, which can be seen in FIG. 6 at the positions 35. The largely constant base level 37 of the current, which is also known as a “standstill current”, can be detected prior to the product position search run or in an initial phase of the product position search run in the form of an average time value. As soon as the current exceeds this average value by a predefined threshold value, it is assumed that a contact of the product gripper 21 with the rear end 30 of the associated product 20a, 20b has taken place.

By determining the product end positions by means of the current increase of the drives 19 in combination with a continuous product position search run, the total product throughput of the cutting apparatus can be increased in a simple manner.

### LIST OF REFERENCE NUMERALS

11 product feed

13 feed unit

15 product gripper module

17 product gripper base

19 electric drive

20a, 20b product

21 product gripper

22 gripping claw

23 abutment

29 front end

30 rear end

35 increase position

37 base level

S cutting plane

Z product feed direction

1. A method for slicing products in which a plurality of products (20a, 20b) are fed next to one another along a product supply direction (Z) to a cutting plane (S) in which a cutting blade moves,
wherein the rear ends (30) of the products (20a, 20b) are brought into engagement with respective product grippers (21) which are attached to a common feed unit (13) and are extendable independently of one another relative to the feed unit (13) in the product feed direction (Z) and are retractable against the product feed direction (Z),
wherein the feed unit (13) is moved in a product position search run along the product supply direction (Z) towards the products (20a, 20b) for the bringing into engagement of the product grippers (21) with the rear ends (30) of the products (20a, 20b), and
wherein, during said product position search run, the current position of the product gripper (21) is determined as the product end position for each product gripper (21) on a contact with the rear end (30) of the associated product (20a, 20b).

2. A method according to claim 1, wherein the cutting blade moves in a rotating and/or revolving manner.

3. A method according to claim 1, wherein the product grippers (21) are extended at least in part prior to the product position search run.

4. A method according to claim 3, wherein the product grippers (21) are extended to a maximum end position prior to the product position search run.

5. A method according to claim 1, wherein the product grippers (21) are moved relative to the feed unit (13) during the product position search run up to a contact with the rear ends (30) of the products (20a, 20b).

6. A method according to claim 1, wherein the feed unit (13) is continuously moved in the product supply direction (Z) during the product position search run.

7. A method according to claim 6, wherein the feed unit (13) is continuously moved at a constant speed during the product position search run.

8. A method according to claim 1, wherein a retraction movement is started for each product gripper (21) after the contact with the rear end (30) of the product (20a, 20b), the speed of which is at least as high in magnitude as the speed of the feed unit (13) during the further product position search run.

9. A method according to claim 1, wherein respective electric drives (19) for the product grippers (21) are brought into a position-regulated state prior to the product position search run.

10. A method according to claim 1, wherein, for detecting a contact of a product gripper (21) with the rear end of the associated product (20a, 20b), an electrical operating variable of a drive (19) of the product gripper (21) is monitored.

11. A method according to claim 10, wherein the electrical operating variable is the electric current supplied to the drive (19).

12. A method according to claim 11, wherein a contact of a product gripper (21) with the rear end (30) of the associated product (20a, 20b) is detected when the electric current supplied to the drive (19) of the product gripper (21) exceeds an average value determined prior to the product position search run.

13. A method according to claim 12, wherein the average value is a predetermined threshold value.

14. A method according to claim 1, wherein, after the product position search run, the product grippers (21) are positioned relative to each other according to the determined product end positions.

15. A method according to claim 14, wherein the feed unit (13) is moved against the product supply direction (Z) away from the products (20a, 20b) prior to positioning the product grippers (21).

16. A method according to claim 14, wherein the positioning of the product grippers (21) takes place starting from the product gripper (21) associated with the longest product (20a).

17. A method according to claim 16, wherein the product gripper (21) associated with the longest product (20a) is entirely retracted.

18. A method according to claim 14, wherein, after positioning the product grippers (21), all product grippers are simultaneously brought into engagement with the rear ends (30) of the products (20a, 20b).

19. A method according to claim 1, wherein the front ends (29) of the products (20a, 20b) are supported at an abutment (23) at least during the product position search run.

20. A method according to claim 1, wherein the determining of the positions of the product grippers (21) as product end positions in each case comprises determining the position of the feed unit (13) relative to the cutting plane (S) or relative to a reference point in relation with the cutting plane (S).

21. An apparatus for slicing products comprising a product feed (11) for feeding a plurality of products (20a, 20b) next to one another along a product feed direction (Z) to a cutting plane (S) in which a cutting blade moves,
wherein the product feed (11) comprises a common feed unit (13) to which respective product grippers (21) are attached for an engagement with the rear ends (30) of the products (20a, 20b), wherein the product grippers (21) are extendable independently of each other relative to the feed unit (13) in the product feed direction (Z) and are retractable against the product feed direction (Z),
wherein a control device is provided which is designed to move the feed unit (13) along the product feed direction (Z) in a product position search run towards the products (20a, 20b) for the bringing into engagement of the product grippers (21) with the rear ends (30) of the products (20a, 20b) and to determine the current position of the product gripper (21) as the product end position during the product position search run for each product gripper (21) on a contact with the rear end (30) of the associated product (20a, 20b).

22. An apparatus according to claim 21, wherein the apparatus is adapted to carry out a method of determining a position of products (20a, 20b) fed next to one another along a product supply direction (Z) to a cutting plane (S).

23. An apparatus according to claim 21, wherein the blades are adapted to move in a rotating and/or revolving manner.

24. An apparatus according to claim 21, wherein the control device cooperates with a detection device which is designed to detect a respective contact of one of the product grippers (21) with the rear end (30) of the associated product (20a, 20b).
